(19) United States
(12) Patent Application Publication
(10) Pub. No.: US 2015/0213250 A1
(43) Pub. Date: Jul. 30, 2015

(54) ELECTRONIC DEVICE AND UNLOCKING CONTROL METHOD

(71) Applicants: Fu Tai Hua Industry (Shenzhen) Co., Ltd., Shenzhen (CN); Hon Hai Precision Industry Co., Ltd., New Taipei (TW)

(72) Inventor: JIAN-GUO WU, Shenzhen (CN)

(21) Appl. No.: 14/589,456

(22) Filed: Jan. 5, 2015

(30) Foreign Application Priority Data
Jan. 25, 2014 (CN) 201410034577.4

(51) Int. Cl. G06F 21/36; G06F 3/0488; G06F 3/0484; G06F 21/34

(52) U.S. Cl. CPC G06F 21/36; G06F 21/34; G06F 3/04883; G06F 3/04842

(57) ABSTRACT

An unlocking control method and an electronic device are provided by this disclosure. The method includes the following steps. Displaying an unlocking prompt interface showing unlocking mode boxes on a touch screen of the electronic device. Generating a selection signal in response to a selection of one of the unlocking mode boxes; wherein each of the unlocking mode boxes associating with an unlocking mode. Controlling the electronic device to enter an unlocking mode associated with the selected unlocking mode box, in response to the selection signal. Displaying an unlocking interface corresponding to the selected unlocking mode. If the electronic device enters a sensing mode, scanning data from a magnetic card placed proximate the scan device and obtaining card data by analyzing and processing the scanned data. Determining whether the card data is consistent with user information stored in the storage device. If yes, unlocking the electronic device.

### CROSS-REFERENCE TO RELATED APPLICATIONS

This application claims priority to Chinese Patent Application No. 201410034577.4 filed on Jan. 25, 2014, the contents of which are incorporated by reference herein.

### FIELD

The subject matter herein generally relates to electronic devices and unlocking control methods, and particularly to an electronic device with more than one unlocking mode and method.

### BACKGROUND

Electronic devices with touch screens, such as mobile phones, digital photo frames, electronic readers (e-reader), for example, are popular. An unlocking procedure such as entering a code or password, or a sliding gesture is needed for unlocking the touch screen.

### BRIEF DESCRIPTION OF THE DRAWINGS

Implementations of the present technology will now be described, by way of example only, with reference to the attached figures.

FIG. 1 shows a block diagram of an electronic device in accordance with an exemplary embodiment.

FIG. 2 is a diagrammatic view showing the electronic device of FIG. 1 displaying an unlocking prompt interface.

FIG. 3 is a diagrammatic view showing the electronic device of FIG. 1 displaying an unlocking interface.

FIG. 4 is a diagrammatic view showing the electronic device of FIG. 1 displaying another unlocking interface.

FIG. 5 is a flowchart of an unlocking method of an electronic device shown in FIG. 1.

### DETAILED DESCRIPTION

It will be appreciated that for simplicity and clarity of illustration, where appropriate, reference numerals have been repeated among the different figures to indicate corresponding or analogous elements. In addition, numerous specific details are set forth in order to provide a thorough understanding of the embodiments described herein. However, it will be understood by those of ordinary skill in the art that the embodiments described herein can be practiced without these specific details. In other instances, methods, procedures and components have not been described in detail so as not to obscure the related relevant feature being described. Also, the description is not to be considered as limiting the scope of the embodiments described herein. The drawings are not necessarily to scale and the proportions of certain parts may be exaggerated to better illustrate details and features of the present disclosure.

Several definitions that apply throughout this disclosure will now be presented.

The term “coupled” is defined as connected, whether directly or indirectly through intervening components, and is not necessarily limited to physical connections. The connection can be such that the objects are permanently connected or releasably connected. The word “module”, “unit” as used hereinafter, refers to logic embodied in hardware or firmware, or to a collection of software instructions, written in a programming language, such as, for example, Java, C, or assembly. One or more software instructions in the modules may be embedded in firmware. It will be appreciated that modules may comprise connected logic units, such as gates and flip-flops, and may comprise programmable units, such as programmable gate arrays or processors. The modules described herein may be implemented as either software and/or hardware modules and may be stored in any type of non-transitory computer-readable storage medium or other computer storage device. The term “comprising,” when utilized, means “including, but not necessarily limited to”; it specifically indicates open-ended inclusion or membership in the so-described combination, group, series and the like.

The present disclosure is described in relation to an unlocking control method for unlocking an electronic device having a storage device, a scan device, and a touch screen. The method includes the following steps. Displaying an unlocking prompt interface showing at least two unlocking mode boxes on the touch screen. Generating a selection signal in response to a selection of one of the at least two unlocking mode boxes, each of the unlocking mode boxes associating with an unlocking mode. Controlling the electronic device to enter an unlocking mode associated with the selected unlocking mode box, in response to the selection signal. Displaying an unlocking interface corresponding to the selected unlocking mode on the touch screen. If the electronic device enters a sensing mode, scanning data from a magnetic card placed proximate the scan device and obtaining card data by analyzing and processing the scanned data. Determining whether the card data is consistent with user information stored in the storage device. And unlocking the electronic device if the card data is consistent with the user information.

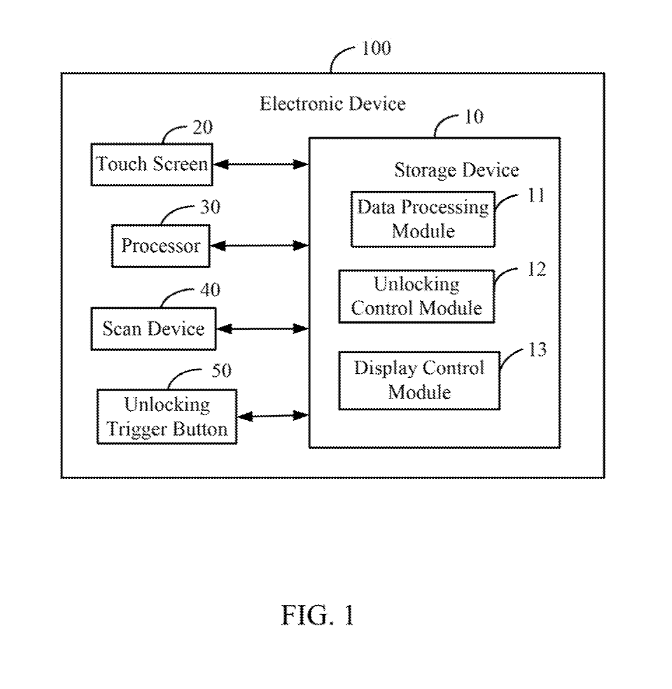

FIG. 1 illustrates a block diagram of an example electronic device 100 of the present disclosure. In at least one embodiment, a user can select an unlocking mode from an unlocking interface displayed on the electronic device 100, and input corresponding unlocking password/data to unlock the electronic device 100. The electronic device 100 has a touch screen and can be a mobile phone, a tablet computer etc.

The electronic device 100 can include a storage device 10, a touch screen 20, a processor 30, a scan device 40, and an unlocking trigger button 50. In at least one embodiment, the scan device 40 is arranged on a back of the electronic device 100, and is electronically coupled to the processor 30. The scan device 40 can be configured to scan user information stored in a magnetic card placed proximate the scan device 40. The magnetic card can have a memory chip recording user information. The magnetic card can be an identity card, a badge, or smart card. In an alternative embodiment, the electronic device 100 can have a display unit and a number of mechanical buttons for inputting information instead of a touch screen 20.

The storage device 10 can store an unlocking password and user information for unlocking the electronic device 100. The unlocking password and the user information are preset by the user of the electronic device 100. The unlocking password can be one or more letters, one or more digits, one or more figures, or combination thereof. In at least one embodiment, the unlocking password is one or more digits. The user information is obtained by scanning a magnetic card placed proximate and scanned by the scan device 40, analyzing and processing the scanned data by the processor 30, and controlling the processed data to be stored in the storage device 10.

The processor 30 is used to execute applications, such as programs, modules installed in the electronic device 100 for implementing the unlocking control method for the electronic device 100. The storage device 10 also can store one or more programs, such as the programs installed in the electronic device 100 for implementing the unlocking control method for the electronic device 100 and applications of the electronic device 100. The storage device 10 can be a storage card, such as a memory stick, a smart media card, a compact flash card, a secure digital card, or any other type of memory storage device.

In at least one embodiment, the storage device 10 can store a data processing module 11, an unlocking control module 12, and a display control module 13. The modules 11-13 include computerized code in the form of one or more programs that are stored in the storage device 10. The computerized code includes instructions that are executed by the processor 30 to provide functions of modules 11-13.

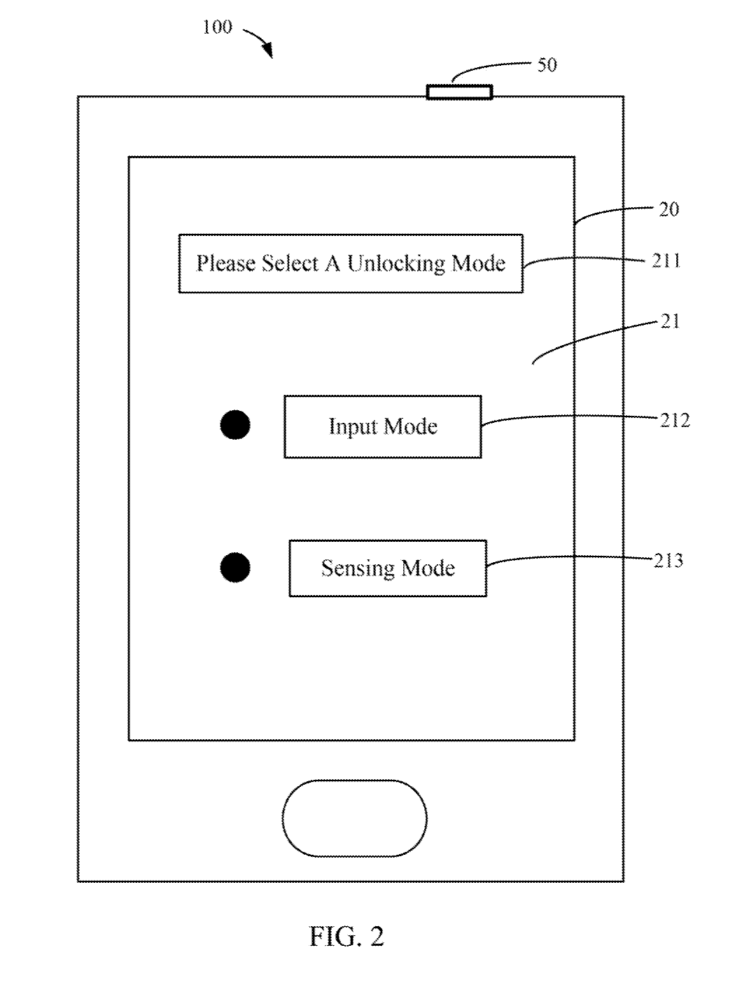

When the unlocking trigger button 50 equipped on the electronic device 100 is depressed, a trigger signal is created and transmitted to the unlocking control module 12. The unlocking module 12 can wake or lock the electronic device 100 according to the trigger signal and the current state of the electronic device 100. In at least one embodiment, the unlocking trigger button 50 can be a mechanical button such as a power button, or a home button, etc. The unlocking trigger button 50 is equipped on the upper right corner of the electronic device 100 (shown in FIG. 2).

FIG. 2 illustrates when the trigger signal is received the display control module 13 controls an unlocking prompt interface 21 to be displayed on the touch screen 20. The unlocking prompt interface 21 shows an unlocking prompt box 211 and at least two unlocking mode boxes. Each of the unlocking mode boxes is associated with an unlocking mode. The unlocking prompt box 211 can be used for prompting a user to select an unlocking mode. In at least one embodiment, the unlocking prompt interface 21 shows a first unlocking mode box 212, and a second unlocking mode box 213 provided for the user to select. When the user selects an unlocking mode on the unlocking prompt interface 21, the display control module 13 controls an unlocking interface corresponding to the selected unlocking mode to display on the touch screen 20.

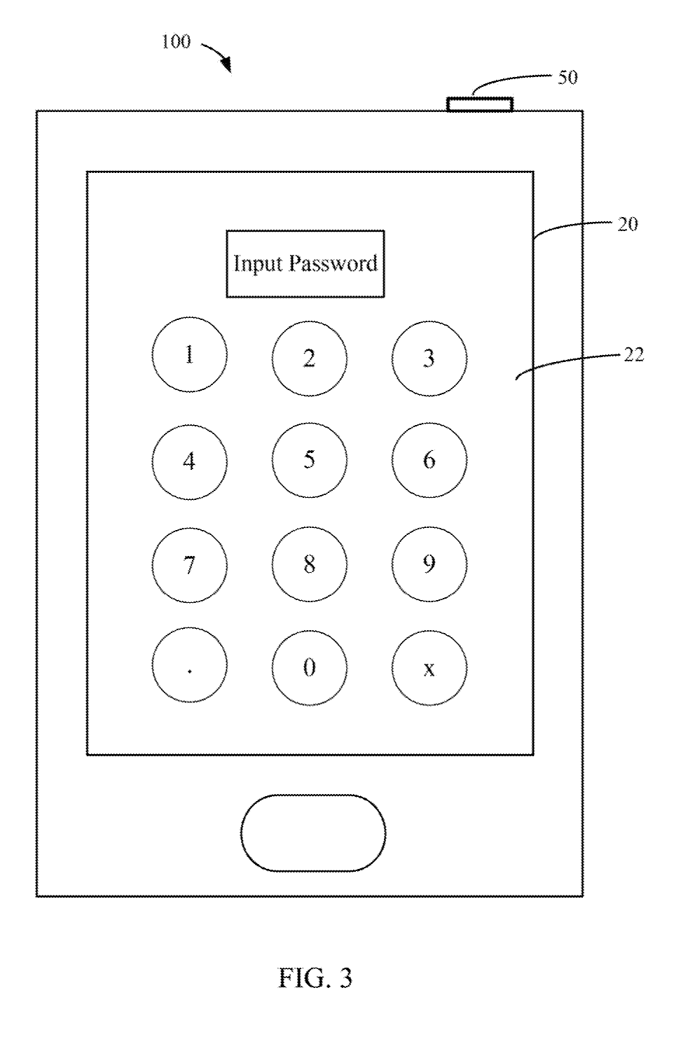

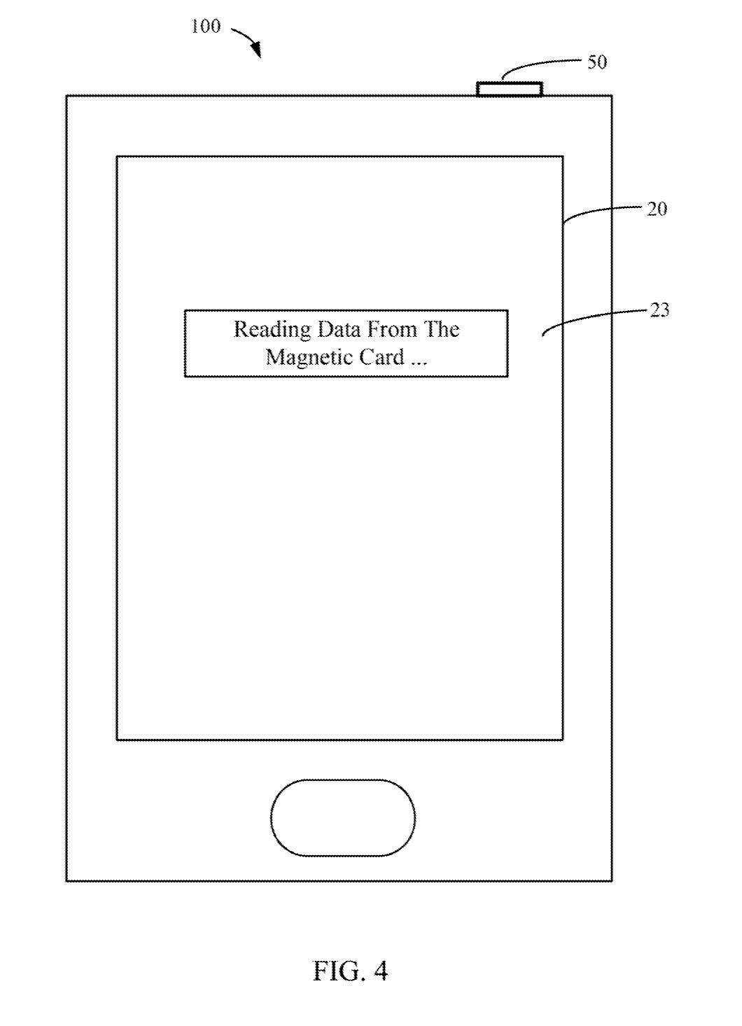

In at least one embodiment, the first unlocking mode box 212 is associated with an input mode, and the second unlocking mode box 213 is associated with a sensing mode. If the user selects the first unlocking mode box 212 shown in FIG. 2 by touching the first unlocking mode box 212, the unlocking control module 12 controls the electronic device 100 to enter the input mode, and the display control module 13 controls the touch screen 30 to display a first unlocking interface 22 corresponding to the input mode (see FIG. 3). If the user selects the second unlocking mode box 213 shown in FIG. 2 by touching the second unlocking mode box 213, the unlocking control module 12 controls the electronic device 100 to enter the sensing mode, and the display control module 13 controls a second unlocking interface 23 corresponding to the sensing mode (see FIG. 4) to display on the touch screen 30. In an alternative embodiment, the unlocking prompt interface 21 can include more than two unlocking mode boxes for the user to select, and the electronic device 100 provides more than two unlocking modes accordingly.

When the electronic device 100 enters the input mode, the user can input an unlocking password on the first unlocking interface 22. The unlocking control module 12 unlocks the electronic device 100 if the unlocking control module 12 determines that the unlocking password input by the user is the same as the unlocking password stored in the storage device 10.

When the electronic device 100 enters the sensing mode, the unlocking control module 12 activates the scan device 40. The scan device 40 begins to scan. When the scan device 40 scans data, the data processing module 11 analyzes and processes the scanned data to obtain card data. The unlocking control module 12 determines whether the obtained card data is consistent with the user information stored in the storage device 10. If the obtained card data is consistent with the user information stored in the storage device 10, the unlocking control module 12 unlocks the electronic device 100. In at least one embodiment, the display control module 13 displays the current unlocking process on the second unlocking interface 23. If the user places a magnetic card (eg. identification card) on the scan device 40, the scan device 40 scans data stored in the magnetic card. As shown in FIG. 4, the unlocking process (reading data from magnetic card) is shown on the second unlocking interface 23. The scan device 40 also converts the scanned data to digital signals, and transmits the converted digital signals to the data processing module 11. The data processing module 11 analyzes and processes the data to obtain the card data.

The display control module 13 displays a user interface on the touch screen 20 after the electronic device 100 is unlocked.

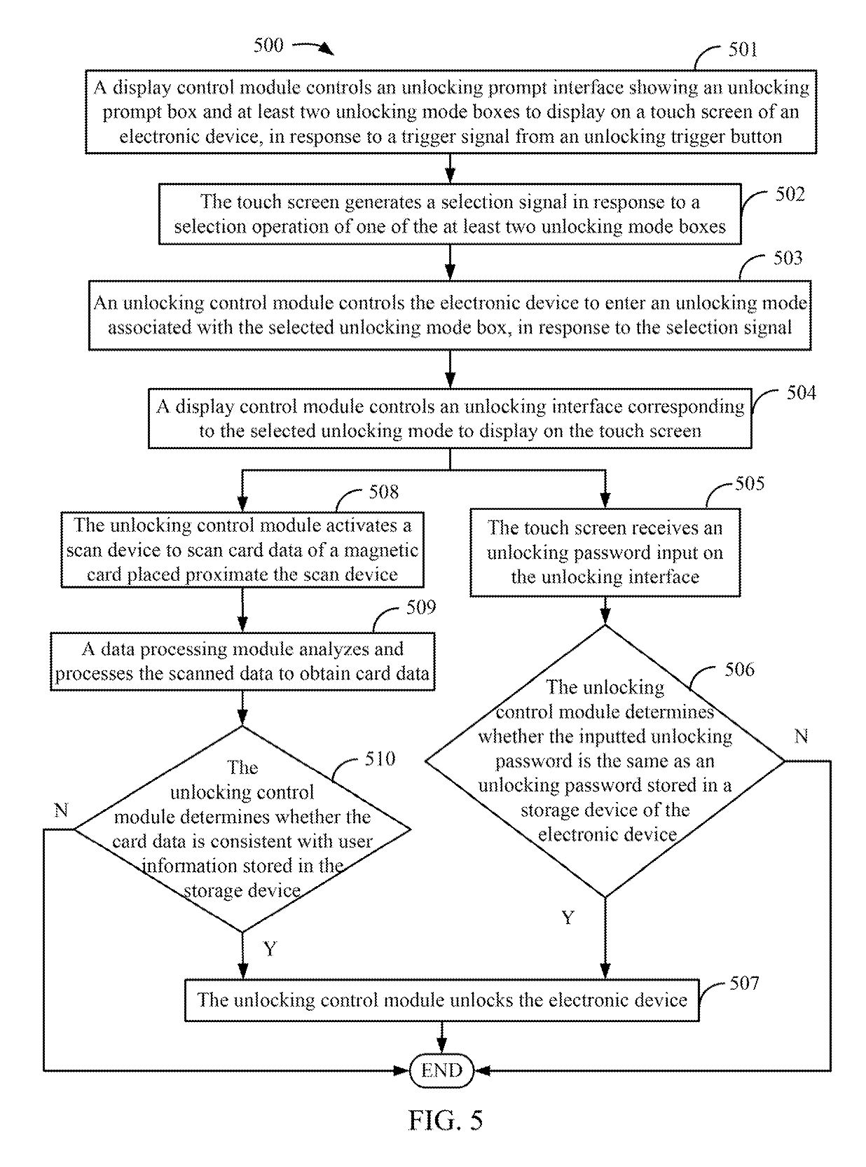

Referring to FIG. 5, a flowchart is presented in accordance with an example embodiment. A method 500 is provided by way of example, as there are a variety of ways to carry out the method. The method 500 described below can be carried out using the configurations illustrated in FIG. 1 and various elements of these figures are referenced in explaining example method 500. Each block shown in FIG. 5 represents one or more processes, methods, or routines, carried out in the exemplary method 200. Furthermore, the illustrated order of blocks is by example only and the order of the blocks can changed. Additional blocks may be added or fewer blocks may be utilized, without departing from this disclosure. The exemplary method 500 can begin at block 501.

At block 501, a display control module controls an unlocking prompt interface showing an unlocking prompt box and at least two unlocking mode boxes to display on a touch screen of an electronic device, in response to a trigger signal from an unlocking trigger button. In at least one embodiment, the unlocking prompt interface shows an unlocking prompt box, a first unlocking mode box, and a second unlocking mode box provided for the user to select. In an alternative embodiment, the unlocking prompt interface is not shown on the touch screen.

At block 502, the touch screen generates a selection signal in response to a selection operation of one of the at least two unlocking mode boxes. In at least one embodiment, each of the unlocking mode boxes is associated with an unlocking mode. If at least one unlocking mode box shown on the unlocking prompt interface is touched, the touch screen generates a selection signal indicating a selection of an unlocking mode associated with the selected unlocking mode box.

At block 503, an unlocking control module controls the electronic device to enter an unlocking mode associated with the selected unlocking mode box, in response to the selection signal.

At block 504, a display control module controls an unlocking interface corresponding to the selected unlocking mode to display on the touch screen. The process goes to execute block 505 or block 508 according to the selected unlocking mode. In at least one embodiment, the display control module controls a first unlocking interface corresponding to the selected first unlocking mode to display on the touch screen, or controls a second unlocking interface corresponding to the selected second unlocking mode to display on the touch screen.

At block 505, the touch screen receives an unlocking password input on the unlocking interface.

At block 506, the unlocking control module determines whether the input unlocking password is the same as an unlocking password stored in a storage device of the electronic device. If yes, block 507 is executed, otherwise, the process ends.

At block 507, the unlocking control module unlocks the electronic device. Then the process ends. In at least one embodiment, after block 507, the display control module also controls the touch screen 20 to display a user interface.

At block 508, the unlocking control module activates a scan device to scan card data of a magnetic card placed proximate the scan device.

At block 509, a data processing module analyzes and processes the scanned data to obtain card data.

At block 510, the unlocking control module determines whether the card data is consistent with user information stored in the storage device. If yes, block 507 is executed, otherwise, the process ends.

The embodiments shown and described above are only examples. Many details are often found in the art such as the other features of an electronic device and an unlocking control method of the electronic device. Therefore, many such details are neither shown nor described. Even though numerous characteristics and advantages of the present technology have been set forth in the foregoing description, together with details of the structure and function of the present disclosure, the disclosure is illustrative only, and changes may be made in the detail, especially in matters of shape, size and arrangement of the parts within the principles of the present disclosure up to, and including, the full extent established by the broad general meaning of the terms used in the claims. It will therefore be appreciated that the embodiments described above may be modified within the scope of the claims.

What is claimed is:

1. An unlocking control method for unlocking an electronic device having a storage device, a scan device, and a touch screen, the method comprising:
displaying an unlocking prompt interface showing at least two unlocking mode boxes on the touch screen;
generating a selection signal in response to a selection of one of the at least two unlocking mode boxes, each of the unlocking mode boxes associating with an unlocking mode;
controlling the electronic device to enter the unlocking mode associated with the selected unlocking mode box, in response to the selection signal;
displaying an unlocking interface corresponding to the selected unlocking mode on the touch screen;
if the electronic device enters a sensing mode, scanning data from a magnetic card placed proximate the scan device and obtaining card data by analyzing and processing the scanned data;
determining whether the card data is consistent with user information stored in the storage device; and
unlocking the electronic device if the card data is consistent with the user information.

2. The method as claimed in claim 1, further comprising:
if the electronic device enters an input mode, receiving an unlocking password inputted on the unlocking interface;
determining whether the inputted unlocking password is the same as an unlocking password stored in the storage device; and
unlocking the electronic device if the inputted unlocking password is the same as the unlocking password stored in the storage device.

3. The method as claimed in claim 1, further comprising:
displaying current unlocking process the unlocking interface.

4. The method as claimed in claim 1, wherein the unlocking prompt interface also showing an unlocking prompt box for prompting a user to select an unlocking mode.

5. An electronic device comprising:
a storage device;
a scan device;
a touch screen; and
a processor, for executing one or more programs stored in the storage device to:
display an unlocking prompt interface showing at least two unlocking mode boxes on the touch screen;
generate a selection signal in response to a selection of one of the at least two unlocking mode boxes, each of the unlocking mode boxes associating with an unlocking mode;
control the electronic device to enter an unlocking mode associated with the selected unlocking mode box, in response to the selection signal;
display an unlocking interface corresponding to the selected unlocking mode on the touch screen;
scan data from a magnetic card placed proximate the scan device and obtaining card data by analyzing and processing the scanned data, if the electronic device enters a sensing mode;
determine whether the card data is consistent with user information stored in the storage device; and
unlock the electronic device if the card data is consistent with the user information.

6. The electronic device as claimed in claim 5, wherein if the electronic device enters an input mode, the touch screen receives an unlocking password inputted on the unlocking interface; and the processor also executes one or more programs stored in the storage device to:
determine whether the inputted unlocking password is the same as an unlocking password stored in the storage device; and
unlock the electronic device if the inputted unlocking password is the same as the unlocking password stored in the storage device.

7. The electronic device as claimed in claim 5, wherein the processor also executes one or more programs stored in the storage device to display current unlocking process the unlocking interface.

8. The electronic device as claimed in claim 5, wherein the unlocking prompt interface also showing an unlocking prompt box for prompting a user to select an unlocking mode.
